(19) United States
(12) Patent Application Publication
(10) Pub. No.: US 2004/0008584 A1
(43) Pub. Date: Jan. 15, 2004

(54) Human-resembled clock capable of bilateral conversations through telecommunication, data supplying system for it, and internet business method for it

(76) Inventor: Kyu Jin Park, Kyungki-do (KR)

Correspondence Address: Warner Norcross & Judd, Intellecutual Property Practice Group, 900 Fifth Third Center, 111 Lyon Street N W, Grand Rapids, MI, 49503-2487, US

(21) Appl. No.: 10/297,447

(22) PCT Filed: May 31, 2001
(86) PCT No.: PCT/KR01/00922

(30) Foreign Application Priority Data
Jun. 8, 2000 (KR) 2000/31259

(51) Int. Cl. G04B 21/08; G04C 21/14

(52) U.S. Cl. 368/63

(57) ABSTRACT

A human type clock capable of mutual talks is disclosed, in which besides the conventional time-displaying and alarming functions, the clock responds in human voices in accordance with the relevant situations, and therefore, a pleasant sense of intimacy is given to a lonely person. Further, the voice of a stage performer or an athletic star whom one likes can be stored and outputted, and a human intelligence type training is possible. The human type clock capable of mutual talks according to the present invention includes the following elements. That is, a central processing unit (301) is loaded with an overall-controlling program, a time function being installed therein, and a data memory (303) stores a voice information. A voice recognizing part (304) receives a voice of a user through a mike (305) to recognize the voice, and a voice outputting part (306) outputs a voice data through a speaker (308) in accordance with the relevant situation. A communication interface (311) is capable of transmitting and receiving a data to and from a communication terminal such as a PC, a hand phone or an IMT2000, whereby the data transmission is possible not only through a conventional wire internet but also through a wireless internet.

### FIELD OF THE INVENTION

The present invention relates to a human type clock, capable of mutual talks. More specifically, the present invention relates to a human type clock capable of mutual talks, in which besides the conventional time-displaying and alarming functions, the clock responds in human voices in accordance with the relevant situations, and therefore, a pleasant sense of intimacy is given to a lonely person. Further, the voice of a stage performer or an athletic star whom one likes can be stored and outputted, and a human intelligence type training is possible.

### BACKGROUND OF THE INVENTION

Clocks are widely used, and owing to the progress in the electronic technology, the clocks are provided with the functions of alarming, time-displaying, calculating and the like. Basically, the clocks are provided with the time-displaying and alarming functions, and the alarming function is provided in the form of bell-sounds and beeps. Accordingly, the alarming sounds are tedious.

Further, there are known the clocks which have composite functions, so that visually handicapped persons or sleeping persons can recognize the time (Japanese patent applications and Korean patent applications). The voice recognizing clock system is based on a combination of the conventional voice recognizing and voice synthesizing technologies.

However, in this conventional voice recognizing clock system, only the user-inputted simple commands can be recognized, and the time is shown in a simple manner, with the result that there is a limit in its use. Further, the synthesized voices are close to the mechanical voices, and therefore, they cannot give the sense of intimacy. Accordingly, this conventional clock system cannot be put into the practical use.

Therefore, there has been arisen a demand for a new clock which is provided with new additional functions of mutual talks to serve as a talk partner for a lonely person, thereby giving the sense of intimacy. Further, instead of the conventional mechanical synthesized voices, this newly demanded clock should be provided with the functions of the time-displaying, alarming and awakening in the voices of a preferred stage performer or sport star, so that the sense of intimacy can be given.

### SUMMARY OF THE INVENTION

The present invention is intended to overcome the above described disadvantages of the conventional techniques.

Therefore, it is an object of the present invention to provide a human type clock in which the functions of the conventional clock are more diversified into the mutually talking functions.

It is another object of the present invention to provide a human type clock in which the particular functions of time-displaying, alarming and awakening are carried out in the voices of a preferred stage performer or a sport star, thereby giving the sense of intimacy.

In achieving the above objects, the human type clock capable of mutual talks according to the present invention includes: a central processing unit 301 loaded with an overall-controlling program, a time function being installed therein; a data memory 303 for storing a voice information; a voice recognizing part 304 for receiving the voice of a user through a mike 305 to recognize the voice; and a voice outputting part 306 for outputting a voice data through a speaker 308 in accordance with the relevant situation.

In another aspect of the present invention, the human type clock capable of mutual talks according to the present invention further includes: a key inputting part 302 for inputting commands; and an LCD driving part 309 for driving an LCD 310, so as to make it possible to do a visual display.

In still another aspect of the present invention, the human type clock capable of mutual talks according to the present invention further includes: a communication interface 311 capable of transmitting and receiving a data to and from a communication terminal such as a PC, a hand phone or an IMT2000, whereby the data transmission is possible not only through a conventional wire internet but also through a wireless internet.

In still another aspect of the present invention, the human type clock capable of mutual talks according to the present invention is characterized in that the voice signals of the data memory 303 are stored after recording the voices of preferred persons such as stage performers, the data memory 303 being either fixed or detachable.

In still another aspect of the present invention, the human type clock capable of mutual talks according to the present invention is characterized in that the voice recognizing part 304 extracts the meaningful portions from the inputted languages, judges the user-intended situation by utilizing a combination of the extracted meaningful portions, and outputs proper voice signals suiting to the user-intended situation.

In still another aspect of the present invention, a data furnishing system is provided in a form of a web server for furnishing the data to the human type clock, and the data is customized suitably to a taste of the user.

It is still another object of the present invention to provide a human type clock which can be connected to a telephone so as to provide a voice-recognized telephone secretary function, and a voice-recognized scheduler function.

It is still another object of the present invention to provide a human type clock in which a human intelligence type training function is possible through talks with the user, thereby making it possible to carry out more practical talks.

It is still another object of the present invention to provide a human type clock in which a data system for various scenarios is built for furnishing various voice data.

### BRIEF DESCRIPTION OF THE DRAWINGS

The above objects and other advantages of the present invention will become more apparent by describing in detail the preferred embodiments of the present invention with reference to the attached drawings in which:

FIG. 1 illustrates the constitution of a system for applying the human type clock according to the present invention;

FIG. 2 is a block diagram of the human type clock according to the present invention;

FIG. 3 is a flow chart showing the operation of the human type clock according to the present invention;

FIG. 4 is a block diagram showing a state in which the human type clock is connected to a wire telephone;

FIG. 5 is a flow chart showing the execution of the automatic recording function, with a telephone being connected; FIG. 6 illustrates a setting status of the human type clock according to the present invention;

FIGS. 7 and 8 illustrate the voice output/response to and from the human type clock according to the present invention; and

FIG. 9 is a flow chart showing a training method using the human type clock according to the present invention.

### * NAMES OF ELEMENTS

10. Web server

20. Personal computer

30. Personal computer

40. Personal computer

50. Human type clock

60. Hand phone

301. Central processing unit.

302. Key inputting part

303. Data memory

304. Voice recognizing part

305. Mike

306. Voice outputting part

307. Amplifier

308. Speaker

309. LCD driving part

310. LCD

311. Communication interface T. Wire telephone

### DETAILED DESCRIPTION OF THE PREFERRED EMBODIMENT

The human type clock and the data furnishing system according to the present invention will be described in detail referring to the attached drawings.

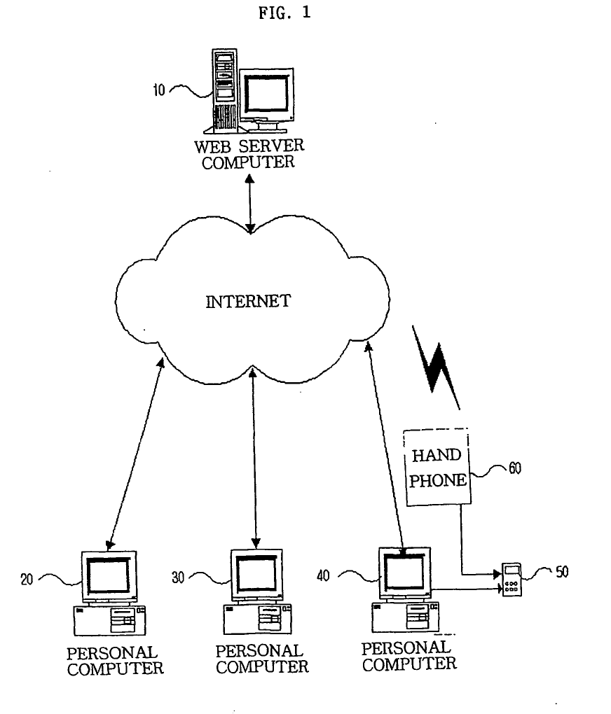

FIG. 1 illustrates the constitution of a system for applying the human type clock according to the present invention.

In this drawing, there are illustrated a plurality of personal computers 20, 30 and 40 which are connected through the internet to a web server 10. The web server 10 is the usual computer which includes a communication function. The web server 10 includes a storing means for storing the recorded data which has been recorded suitably to the relevant situation. The voice data which has been stored in the storing means can be the voices of particular stage performers.

For example, there are stored into the database the voices of a popular stage performer as to (1) morning awakening service, (2) mealtime confirming service, (3) evening sleeping time, (4) birthday congratulation, (5) appointment time confirmation, (6) early return-home and the like.

A user can be connected to the web server 10, so that the desired voices of a preferred stage performer can be downloaded from among the contents of the database to store them and to use them when they are wanted.

Further, advertisement contents can be put into the voice data, so that an advertisement can be carried out. If a user downloads the advertisement-included voice data, a discount or a no charge giving may be granted to the user, thereby promoting the advertising effects.

The voice data can be stored into the database in various digital audio file formats such as wave, mp3, Aac, WMA and the like.

That is, the voice of a stage performer can be stored in a form of a digital audio file, or an audio tape can be converted into the digital audio file. Particularly, the apparatus of the present invention can be applied to the conventional mp3 player or to a caption-functioning language learning apparatus, thereby diversifying the functions. Further they can be applied to an advertisement.

The user can download the desired kind of voices from the web server 10 through his or her PC 40 to store them into the data memory of the human type clock. As much as the downloaded volume of the voices, a billing is made to the user. Or if an advertisement is loaded in the voices, then a discount can be granted to the user, or the voice recording may be given at no charge.

To describe it again, the database of the web server 10 is built by using the voices of particular persons such as stage performers and sport stars and the like, thereby catering to the tastes of users. That is, various scenarios are formed on love affairs, love failures, business success and the like, and thus they are furnished to the users.

The users can select the desired voices and the situations so that various suitable data can be received. Further, the selection of a key word data is possible, so that human intelligence type training can be possible.

Not only this kind of data, but also an advertisement can be inserted into the downloading voices, and in this case, a discount or a gratuitous giving can be allowed. Accordingly, the user can enjoy the satisfactory talks suitably to the situation based on the self-selected type of voices. This data can be obtained by the user from the web server 10 through the wire or wireless internet.

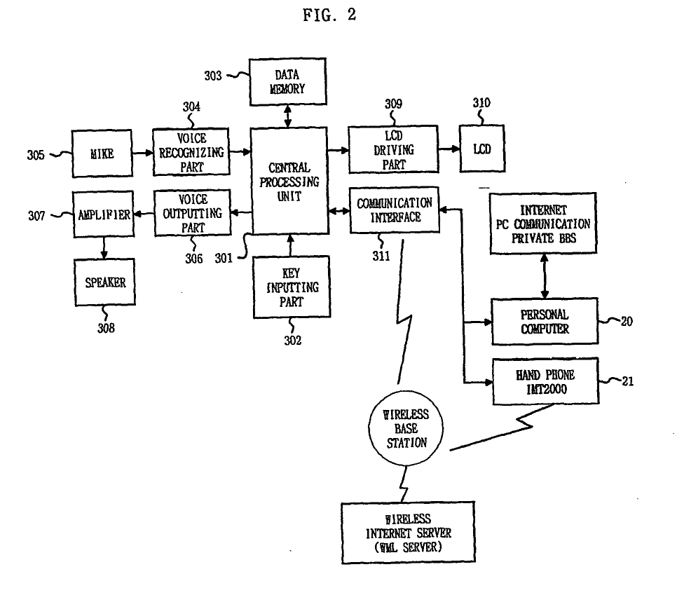

Referring to FIG. 2, in the human type clock of the present invention unlike the conventional clock is not provided with a visual display function, but with a vocal function, so that the control commands can be inputted by voices, and the time and alarming functions can be outputted in voices. The human type clock capable of mutual talks according to the present invention includes: a central processing unit 301 loaded with an overall-controlling program, a time function being installed therein; a data memory 303 for storing a voice information; a voice recognizing part 304 for receiving the voice of a user through a mike 305 to recognize the voice; and a voice outputting part 306 for outputting a voice data through a speaker 308 in accordance with the relevant situation.

In another aspect of the present invention, the human type clock capable of mutual talks according to the present invention further includes: a key inputting part 302 for inputting commands; and an LCD driving part 309 for driving an LCD 310, so as to make it possible to do a visual display.

In still another aspect of the present invention, the human type clock capable of mutual talks according to the present invention further includes: a communication interface 311 capable of transmitting and receiving a data to and from a communication terminal such as a PC, a hand phone or an IMT2000, whereby the data transmission is possible not only through a conventional wire internet but also through a wireless internet.

Through the interface with the personal computer, the data transmission and reception can be carried out by utilizing the wire connection means or the infrared ray transmission method such as the conventional serial and parallel ports, or the USB (universal serial bus), or by utilizing the wireless connection means such as bluetooth. Further, the data transmission and reception can be carried out by utilizing the data transmission/reception ports of a hand phone or the IMT2000.

The data transmission and reception ports indicate the data communication connector which enables the use of the wireless internet through a notebook computer. Accordingly, in the human type clock of the present invention, the data transmission and reception are possible even without installing a separate wireless transmission and reception device. Of course, if a separate wireless transmission and reception device is installed, then a data downloading can be carried out even without resorting to a hand phone or IMT2000.

The human type clock of the present invention is an improvement of the simple query and the simple response of the conventional voice recognizing clock. That is, the mutually talking function is added, thereby carrying out a complementation. In this function, more refined voices can be introduced.

The central processing unit 301 is for controlling the overall operation of the human type clock of the present invention, and is made to work by its internal program. If the user connects his or her human type clock to the personal computer 40 (connected to the web server 10), and if the user gives a file downloading command, then the voice data file of the database of the web server 10 is transmitted to the personal computer 40, and then, the data file is transmitted to the central processing unit 301 to be stored in the data memory 303 of the human type clock.

The storing into the data memory 303 is done for each of the stage performers based on the database method. The data memory 303 should be preferably consisting of a large scale memory such as the flash memory in which the read/write can be freely carried out. Instead of downloading the voice data file from the web server 10 into the data memory 303, there can be used a detachable data memory 303 and a separate downloading device for updating the data.

Or by utilizing a file vending machine, the data memory 303 can be updated or altered.

The central processing unit 301 has a control program and a time function. The voice commands of the user are inputted through a mike 305 into the voice recognizing part 304. The voice recognizing part 304 analyzes the inputted command voices, and compares them with reference voices, thereby judging the user's inputted command contents. In the human type clock of the present invention, unlike in the conventional voice recognizing system, the voice recognizing part 304 extracts the meaningful parts of the plurality of words, analyzes and judges the situation which the user wants.

For example, if the user inputs “my dear, awaken me at 7 o'clock” then the voice recognizing part 304 recognizes “my dear”, “me”, and “7 o'clock”, and then, extracts the meaningful parts. Then the voice recognizing part 304 judges the situation, and thus, recognizes the critical portions such as “7 o'clock” and “awaken”, thereby judging the situation of awakening at 7. Such a word-recognizing database which includes the possibly usable words is built in advance, and the word-recognizing database is stored in the human type clock.

If the situation and the information of the user are recognized by the voice recognizing part 304, then the central processing unit 301 confirms it. That is, the information which is recognized by the voice recognizing part 304 is stored in the central processing unit 301 as an activation data. Then if the user's designated time arrives, then the activation data is outputted.

The voice outputting part 306 outputs the voice signals suitably to the relevant situation in accordance with the user's inputted command. The outputted voice signals are amplified by the amplifier 307, and then, are outputted through the speaker 308. The voice outputting form is not unaltered, but can be altered in accordance with the user response, and this is controlled by the central processing unit 301.

The voice outputting part 306 includes a converter which is suitable for reproducing the voice data signals of the data memory 303. In other words, if the voice data has been stored in the mp3 method, then there are included a DA converter and a decoder capable of converting the signals into analogue signals. This is the same case also in other digital audio files such as wave, AC3, AAC, WMA and the like.

The LCD 310 and the LCD driving part 309 are used for displaying the time and for displaying the inputted command. The time display is easily realized by the counting function and by the frequency oscillation function of the central processing unit 301.

Through the communication interface 311 which is connected to the central processing unit 301, the data transmission and reception can be carried out to and from a communication terminal such as the personal computer 20, the hand phone 21, or the IMT2000.

That is, in the case where a connection is made to the wire internet, an interface is formed such that the personal computer 40 can use a modem or an exclusive line. On the other hand, in the case where the wireless internet is used, an interface is formed such that a hand phone can be used. Particularly, in the case of the communication interface 311 of the human type clock, both the wire internet and the wireless internet should be desirably made to be usable.

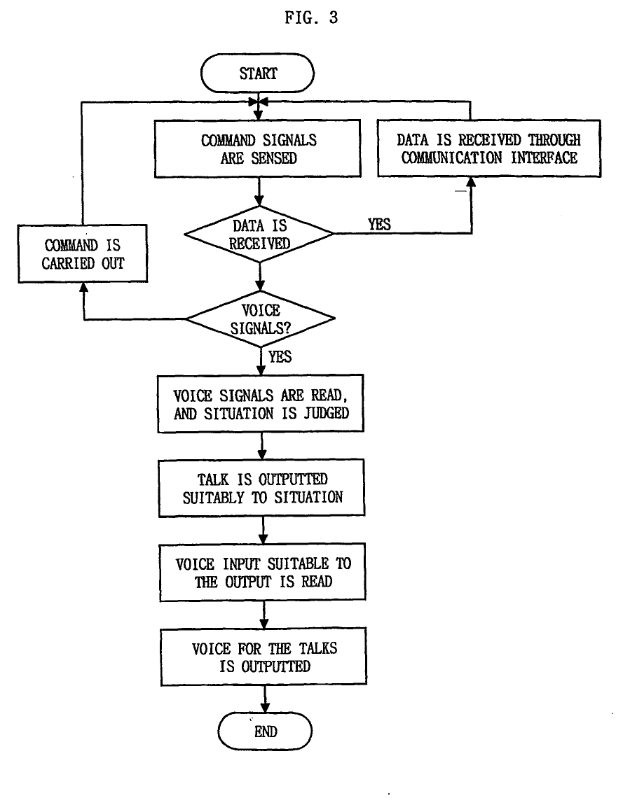

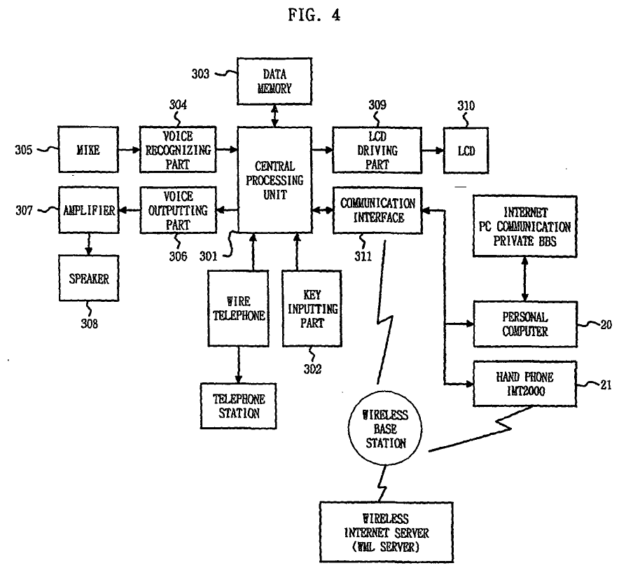

FIG. 3 is a flow chart showing the operation of the human type clock capable of mutual talks according to the present invention;

For the sake of the describing convenience, it is assumed that a plurality of voice data have been stored in the data memory 303, and that word databases for different situations have been built in the voice recognizing part 304.

The human type clock waits for an inputting of a command through the key inputting part 302 (in the case where a key inputting part and an LCD are equipped), or waits for an inputting of a voice command. Under this condition, if a voice command or a key command is inputted, then the central processing unit 301 interprets the inputted command. The command which has been inputted through the key inputting part 302 is directly processed by the central processing unit 301, while the voice command is inputted through the voice recognizing part 304.

FIG. 6 illustrates a setting status of the human type clock according to the present invention. As shown in this drawing, there is wanted an awakening signal. Thus, an operation is executed at 7 o'clock, and the voice is that of a person named “Kim Hye Sun”.

When the key command or voice command has been interpreted, if it is judged to be a data reception, then the central processing unit 301 confirms as to whether the system is in a standby status for receiving the data through the communication interface 311. Then the central processing unit 301 connects itself to the web server 10 to download the voice data file which is wanted by the user.

In the case where a voice data file is downloaded from the web server 10, the user can select the desired voice data through the key inputting part 302 while watching the LCD 310, or can use the personal computer 40 to download the desired voice data file.

If a voice command is inputted through the mike 305, then the voice recognizing part 304 reads the voice signals and judges on the situation. An example will be described referring to FIG. 6. If the user inputs “awaken me at 7 o'clock, Kim Hye Sun”, then the voice recognizing part 304 recognizes the words “7 o'clock” and “awaken”, and judges on the situation.

The voice recognizing part 304 can be constituted in a form of either talker subordination or talker independence. In other words, in the form of talker subordination, a learning procedure for recognizing only a particular person's voice is carried out. Meanwhile, in the form of talker independence, any talkers' voices can be recognized.

The voice recognizing part 304 can be constituted in a form of a chip which stores a voice recognizing function. The voice recognizing chip can recognize the words, and the recognized words are sent to the central processing unit 301.

If a voice command is inputted, since the voice recognizing part 304 stores the situation word database, the voice recognizing part 304 searches for the words, and coverts the inputted voice into words to send the converted result to the central processing unit 301.

The central processing unit 301 judges the command to be an awakening at 7 A.M., and the clock asks to the user “can you really get up?”. Then the user replies “of course”. Then the clock confirms, “you will have to surely get up”, or “is it an awakening request?”

Thus if the situation is judged and stored, then the central processing unit 301 stores the confirmed contents, and activates the internal watch, and waits until the designated time arrives. Then after elapsing of time, if the designated time approaches, then at 6:50, the central processing unit 301 outputs a tender voice “it is the time for you to get up”.

Under this condition, the user inputs the word “thanks” into the human type clock, so that no more services would be outputted.

However, if the user makes no response, the central processing unit 301 awakens the user again in about 5 minutes thereafter saying “it is the time for you to get up” in a slightly stronger voice. Under this condition, if the user inputs the voice “thanks”, then the voice data will be outputted no more.

However, if the user makes still no response, the central processing unit 301 says after elapsing of a certain period of time (about 5 minutes) “so what did I say? I hate to live with you” in a loud and threatening voice. Thus the user can be surely awakened. The voice output is made in the voice of Kim Hye Sun, so that the attention of the user can be called.

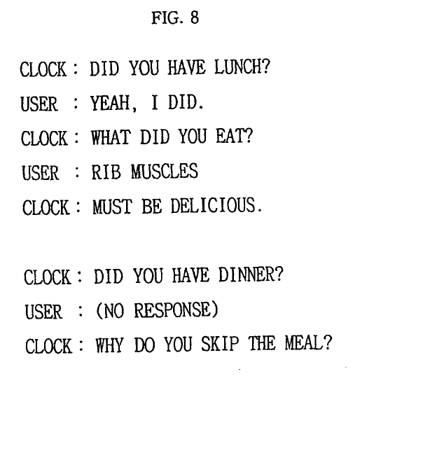

FIG. 8 illustrates another embodiment of the present invention.

As shown in this drawing, when confirming as to whether the user had lunch, the clock says like a wife or another member of the family, so that the user can feel as if he or she has a family even if he or she lives by himself or herself. Accordingly, such a single can be consoled as if he or she has a family.

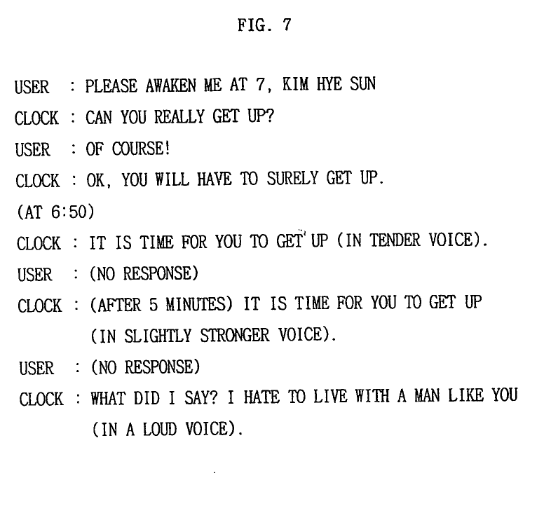

It is apparent that the present invention can be applied not only to the situations of FIGS. 7 and 8, but also can be applied to all other kinds of situations. Further, the external appearance of the clock may be made to be like that of a favorite stage performer or an animal, so that an intimacy can be felt.

Further, the present invent ion can be connected to the conventional wire telephone in such a manner that an automatic answering service or a scheduling service can be provided. That is, the transceiver of an electronic telephone is connected to the voice recognizing part and to the voice outputting part, and thus, the voice of the other talking party can be recorded, the recorded voice of the user can be transmitted, and a scheduling can be managed.

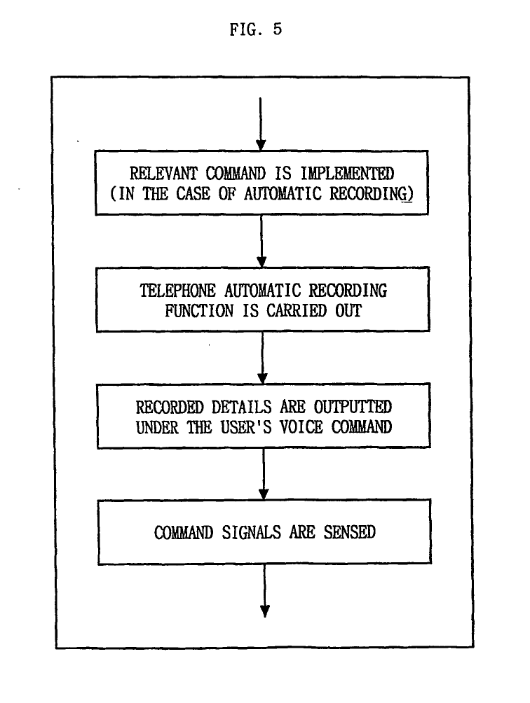

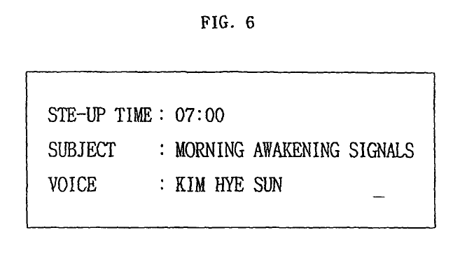

Referring to FIGS. 4 and 5, in a state with the human type clock connected to an electronic telephone, if a telephone call arrives, and if an absence mode or an automatic answering mode has been set, then a pre-inputted voice can be transmitted to the calling party, thereby carrying out an automatic answering function.

During the automatic answering, if the voice of the calling party is inputted, then the human type clock stores it so that the user can reproduce the inputted voice of the other party directly or at a remote place. Thus the user can recognize the voice of the calling party. The connection of the human type clock to the conventional wire telephone can be easily carried out, and therefore, any further details will be skipped.

The human type clock of the present invention can have a human intelligence type training function. The human intelligence type training function can be activated by selecting the learning mode as described in connection with the web server 10 of FIG. 1. That is, if the learning mode is selected from the database of the web server 10, then a human intelligence type key words can be downloaded. The examples of the key words are “item: personal matters”, “key words: body weight, date of birth, family, names” and the like.

Thus with the human intelligence type key words being stored, the personal matters of the user are formed into a database. The information of the database will be referred to when carrying out talks later. Further, not only the personal matters, but also other key words such as the taste of the user, the inclination of the user, the character of the user and the like can be selected, so that they can be referred to when carrying talks later.

For example, if the words “body weight” are inputted during the talks with the human type clock, and if it is found that the body weight has been increased, a rebuke is outputted saying that the increase is not desirable. If it is found that the body weight has been decreased, then praise is outputted saying that you have got slim.

To cite another example, if a sentence such as “I will be 30 years old by tomorrow my birth day” is inputted, then the central processing unit 301 of the clock reads the date (June 1), and judges that the birthday of the user is June 2, and this personal matter is stored.

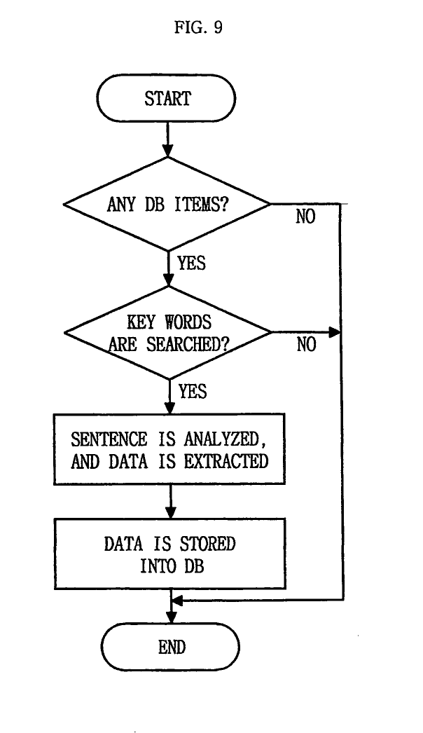

On the same day the next year, the clock will output a message “congratulations on your birthday”, thereby reminding the birthday of the user. The details of this are shown in FIG. 9. In the human intelligence training function, if the user inputs a voice, then the voice recognizing part confirms the words, and the central processing unit 301 carries out the training.

According to the present invention as described above, in addition to the time-displaying and alarming functions, the clock responds to the user in an intimate voice in accordance with the situations, and therefore, absolute singles can be consoled as if he or she has a family. Further, the voice of a favorite stage performer can be recorded in the clock, and a human intelligence type training can be carried out with a sense of reality.

In the above, the present invention was described based on the specific preferred embodiments and the attached drawings, but it should be apparent to those ordinarily skilled in the art that various changes and modifications can be added without departing from the spirit and scope of the present invention, which will be defined in the appended claims.

What is claimed is:

1. A human type clock capable of mutual talks, comprising: a central processing unit 301 loaded with an overall-controlling program, a time function being installed therein; a data memory 303 for storing a voice information; a voice recognizing part 304 for receiving a voice of a user through a mike 305 to recognize the voice; and a voice outputting part 306 for outputting a voice data through a speaker 308 in accordance with a relevant situation.

2. The human type clock as claimed in claim 1, further comprising: a communication interface 311 connected to the central processing unit 301 and capable of transmitting and receiving a data to and from a communication terminal such as a PC, a hand phone or an IMT2000, whereby the data transmission is possible not only through a conventional wire internet but also through a wireless internet.

3. The human type clock as claimed in claim 1, wherein the data memory 303 is detachable.

4. The human type clock as claimed in claim 1, wherein voice signals of the data memory 303 are voices of a particular person such as a stage performer, and the voice signals are formed into a scenario in accordance with relevant situations so as to be stored.

5. The human type clock as claimed in any one of claims 1 to 4, wherein the voice data is stored in a form of a digital audio file format such as wave, mp3, AC3, AAC, or WMA.

6. The human type clock as claimed in claim 1, wherein the voice recognizing part 304 extracts meaningful words from user's inputted words to judge on the situation wanted by the user so as to output suitable voice signals.

7. The human type clock as claimed in any one of claims 1 to 6, wherein the voice recognizing part 304 recognizes an inputted command only if the command is based on a voice recognition training under a talker subordination method.

8. The human type clock as claimed in claim 1, further comprising: a key inputting part 302 for inputting commands to visually display the operation status; and an LCD driving part 309 for driving an LCD 310, so as to output characters under a control of the central processing unit 301.

9. The human type clock as claimed in claim 1, wherein the clock is connected to a wire telephone to carry out an automatic talk recording, and to output the talk recording under a voice command of the user.

10. A data furnishing system comprising: a web server 10; and a plurality of personal computers 20, 30 and 40 connected through an internet to a web server 10; characterized in that the web server 10 is a usual computer having a communication function, and includes a database for storing various data for different subjects and different situations.

11. The data furnishing system as claimed in claim 10, wherein voice data of the database are classified into scenarios for different subjects and different situations.

12. The data furnishing system as claimed in claim 10, wherein the different subjects are stored in a form of voice data of friends, love partners, married couples, teachers, and brothers.

13. The data furnishing system as claimed in any one of claims 10 and 11, wherein the different situations are a morning awakening service, a telephone call notifying service, a home-return imploring service and any combination of them.

14. The data furnishing system as claimed in any one of claims 10 and 11, wherein a recognition of the different situations includes: (1) co-pleasing words for a pleasant mood; and (2) sympathizing or consoling words for a sad mood.

15. The data furnishing system as claimed in any one of claims 10 and 11, wherein the particular persons comprises: stage performers such as movie stars, talents, singers, announcers, sport stars and so on.

16. The data furnishing system as claimed in any one of claims 10 and 11, wherein the particular persons comprise: one of actual persons such as lover partners, marriage couple and parents of the user.

17. The data furnishing system as claimed in any one of claims 10 and 11, wherein during a recording of the voice data, advertisements are added.

18. The data furnishing system as claimed in claim 7, wherein a discount or a no charge is granted to those who buy the voice data files containing some advertisements.

19. A human intelligence type training method using a human type clock capable of mutual talks, comprising the steps of: checking as to whether there is a key word database upon starting a talk with a user; extracting user's inputted words upon finding a presence of the key word database, and judging as to whether the words thus extracted have been stored in the key word database; setting up items for the key words (if they exist), and classifying them; and storing the words (thus classified) into the database.

20. The human intelligence type training method as claimed in claim 19, wherein human intelligence type key words are downloaded from a web server to store them in the human type clock.

21. A storage medium for storing a program to carry out a human intelligence type training method by using a human type mutually talkable clock, and for storing various data produced by the program.

22. A storage medium for storing a program to form a data furnishing system, and for storing various data produced by the program.
